(19) United States
(12) Patent Application Publication
(10) Pub. No.: US 2022/0385546 A1
(43) Pub. Date: Dec. 1, 2022

(54) SYSTEMS AND PROCESSES FOR ITERATIVELY TRAINING A NETWORK TRAINING MODULE

(71) Applicant: Job Market Maker, LLC, Charleston, SC (US)

(72) Inventors: Marc Wong, Charleston, SC (US); Christina R. Petrosso, Folly Beach, SC (US); Joseph W. Hanna, Ft. Lauderdale, FL (US); David Trachtenberg, Charleston, SC (US)

(21) Appl. No.: 17/830,201

(22) Filed: Jun. 1, 2022

Related U.S. Application Data
(60) Provisional application No. 63/195,264, filed on Jun. 1, 2021.

(51) Int. Cl. H04L 41/16; H04L 43/04; H04L 41/14

(52) U.S. Cl. CPC H04L 41/16; H04L 43/04; H04L 41/145

(57) ABSTRACT

Systems and processes for iteratively training a network training module are described herein. In various embodiments, the process includes: (1) retrieving bulk data comprising a plurality of a data types, (2) transforming the bulk data according to preconfigured classification values to generate network information data sets; (3) training a raw training module by iteratively processing each of the network information data sets through a raw training module to generate respective output classification values; (4) updating one or more classification values based on a comparison of the respective output classification values; (5) processing an input network information data set with a trained training module to generate a specific network constituent; and (6) modifying a display based on the plurality of classification values.

### CROSS-REFERENCE TO RELATED APPLICATIONS

This application claims the benefit of and priority to U.S. Patent Application No. 63/195,264 filed Jun. 1, 2021, entitled “SUPPLIER OPTIMIZATION MACHINE LEARNING SYSTEMS AND PROCESSES,” which is incorporated herein by reference in its entirety.

### BACKGROUND

Present computing systems for evaluating network outcomes generally lack detailed, objective, and complete information data sets. Existing systems lack the ability to extract and transform raw information data sets into an individualized communication for optimized network outcomes and network updates based on a plurality of data types and specific classification values.

### BRIEF SUMMARY OF THE DISCLOSURE

Briefly described, and according to one embodiment, aspects of the present disclosure generally relate to systems and processes for iteratively training a network training module for processing and transforming raw information data sets from a plurality of data sources. In various embodiments, the disclosed process and system retrieves data from a plurality of data sources and then uses processes for iteratively training a network training module to transform the data and arrive at specific network constituent recommendations based on one or more classification values and tunable emphasis guidelines.

In various embodiments, the present system may implement various training modules and data transformation processes to produce a dynamic data analytics system. In at least one embodiment, the output of the system may include, but is not limited to, a specific network constituent recommendation for an input network information data set based on a plurality of classification values.

In at least one embodiment, the system is configured to automatically (or in response to an input) collect, retrieve, or access data from a plurality of data sources. In some embodiments, the plurality of data sources can include a large number of sources including at least 40,000 sources. In various embodiments, the system is configured to automatically analyze and index accessible sources to obtain classification data, profile data, diversification data, and/or other information. In one or more embodiments, the system is configured to automatically access and process bulk data and/or other information stored in one or more databases operatively connected to the training module system. In various embodiments, the system retrieves data by processing electronic documents, web pages, and other digital media. In some embodiments, the system processes individual data, position descriptions, reviews, and other digital media to obtain seeker, position, location data, and/or other information.

In at least one embodiment, the system may include data from a plurality of sources for creating a taxonomy. In certain embodiments, the system may include one or more algorithms to automatically update and train the taxonomy. For example, in some embodiments, data corresponding to the categories in the taxonomy can be processed with the one or more algorithms to generate a plurality of classification values. In various embodiments, the system may include an interface for operating and controlling the various facets of the taxonomy and training system as described herein.

In one or more embodiments, the present system may transform the data from the plurality of data sources for analysis via the training module processes and other techniques described herein. In at least one embodiment, the present system may clean and transform data to remove, impute, or otherwise modify missing, null, or erroneous data values. In various embodiments, the present system may remove identifying information in order to anonymize and remove any correlated data. Similarly, the system may index and correlate specific data elements, data types, and data sets to facilitate the network training module training process.

In one or more embodiments, the present system may include one or more processes for training a network training module. In various embodiments, the present system may iteratively retrieve, transform, and update training modules in order to compare input network information data sets with preconfigured threshold classification values.

According to a first aspect, the present disclosure includes a process for generating a network related output, the process comprising: compiling a plurality of network information training data sets, each of the plurality of network information training data sets having a respective one of a plurality of data types and a respective known classification value specific to the respective one of the plurality of data types; training a plurality of raw training modules with the plurality of network information training data sets by iteratively: inputting each of the plurality of network information training data sets into a plurality of raw training modules based on the respective one of the plurality of data types thereof; comparing outputs of the plurality of raw training modules to the respective known classification value for the input ones of the plurality of network information training data sets; updating one or more emphasis guidelines for a respective plurality of nodes of the plurality of raw training modules based on results of the comparing step; when the outputs of the plurality of raw training modules are within a preconfigured threshold of the respective known classification value for the input ones of the plurality of network information training data sets, outputting current updated versions of the plurality of raw training modules as a plurality of trained training modules; receiving a plurality of input network information data sets associated with a specific network constituent, each of the plurality of input network information data sets having a respective one of the plurality of data types; inputting each of the plurality of input network information data sets through a respective one of the plurality of trained training modules based on the respective one of the plurality of data types thereof; receiving a plurality of classification values as outputs from the plurality of trained training modules; determining whether to add or remove the specific network constituent from an approved network list using the plurality of classification values; and modifying a display based on the plurality of classification values.

In a second aspect of the process for generating the network related output of the first aspect or any other aspect, determining whether to add or remove the specific network constituent from the approved network list using the plurality of classification values comprises: comparing the plurality of classification values to respective threshold values; determining whether the specific network constituent is presently included in the approved network list; removing the specific network constituent from the approved network list when the specific network constituent is determined to be presently included in the approved network list and one or more of the plurality of classification values are below the respective threshold values; adding the specific network constituent to the approved network list when the specific network constituent fails to be determined to be presently included in the approved network list and each of the plurality of classification values are above the respective threshold values.

In a third aspect of the process for generating the network related output of the first aspect or any other aspect, determining whether to add or remove the specific network constituent from the approved network list using the plurality of classification values comprises: inputting the plurality of classification values into a trained network constituent approval model; and receiving a directive to add or remove the specific network constituent from the approved network list as an output of the trained network constituent approval model.

In a fourth aspect, the process for generating the network related output of the first aspect or any other aspect further comprises: training the trained network constituent approval model by iteratively: inputting a plurality of known classification values into the trained network constituent approval model, each of the plurality of known classification values being associated with a known approved or rejected network constituent; comparing an output of the trained network constituent approval model to known approved or rejected network constituent for the input plurality of known classification values; and updating the trained network constituent approval model based on results of the comparing step.

In a fifth aspect, the process for generating the network related output of the first aspect or any other aspect further comprises: retrieving proprietary bulk data from proprietary data sources and non-proprietary bulk data from non-proprietary data sources; and transforming the proprietary bulk data and the non-proprietary bulk data into the plurality of network information training data sets according to preconfigured classification values.

In a sixth aspect of the process for generating the network related output of the fifth aspect or any other aspect, the proprietary bulk data includes internal reporting on a plurality of network constituents, wherein the non-proprietary data includes self-reporting on the plurality of network constituents from each of the plurality of network constituents.

In a seventh aspect of the process for generating the network related output of the first aspect or any other aspect, the plurality of data types include network metrics relating to at least one of quality, participation, speed, and cost.

In an eighth aspect, the process for generating the network related output of the first aspect or any other aspect further comprises: compiling an updated plurality of network information training data sets corresponding to each of the plurality of data types, each of the updated plurality of network information training data sets having a respective updated known classification value; retraining the plurality of trained training modules with the updated plurality of network information training data sets by iteratively: inputting each of the updated plurality of network information training data sets into the plurality of trained training modules based on the respective one of the plurality of data types thereof; comparing outputs of the plurality of trained training modules to the respective updated known classification value for the input ones of the updated plurality of network information training data sets; and updating the one or more emphasis guidelines for the respective plurality of nodes of the plurality of trained training modules based on results of the comparing step.

In a ninth aspect, the process for generating the network related output of the first aspect or any other aspect further comprises: after modifying the display, receiving changes to the plurality of input network information data sets; processing the changes to the plurality of input network information data sets with the trained training module to generate an updated plurality of classification values; and modifying the display based on the updated plurality of classification values.

In a tenth aspect, the process for generating the network related output of the first aspect or any other aspect further comprises: generating a plurality of graphical user interface displays that include the plurality of classification values; receiving user input on at least one of the plurality of graphical user interface displays, the user input modifying the plurality of input network information data sets; processing the plurality of input network information data sets as modified with the trained training module to generate an updated plurality of classification values; and generating the updated plurality of classification values on the plurality of graphical user interface displays.

According to an eleventh aspect, the present disclosure includes a system for generating a network related output, the system comprising: a memory unit; a processor in communication with the memory unit, the processor configured to: compile a plurality of network information training data sets from the memory unit, each of the plurality of network information training data sets having a respective one of a plurality of data types and a respective known classification value specific to the respective one of the plurality of data types; train a plurality of raw training modules with the plurality of network information training data sets by iteratively: inputting each of the plurality of network information training data sets into a plurality of raw training modules based on the respective one of the plurality of data types thereof; comparing outputs of the plurality of raw training modules to the respective known classification value for the input ones of the plurality of network information training data sets; updating one or more emphasis guidelines for a respective plurality of nodes of the plurality of raw training modules based on results of the comparing step; when the outputs of the plurality of raw training modules are within a preconfigured threshold of the respective known classification value for the input ones of the plurality of network information training data sets, output current updated versions of the plurality of raw training modules as a plurality of trained training modules; receive a plurality of input network information data sets associated with a specific network constituent, each of the plurality of input network information data sets having a respective one of the plurality of data types; input each of the plurality of input network information data sets through a respective one of the plurality of trained training modules based on the respective one of the plurality of data types thereof; receive a plurality of classification values as outputs from the plurality of trained training modules; determine whether to add or remove the specific network constituent from an approved network list using the plurality of classification values; and modify a display based on the plurality of classification values.

In a twelfth aspect of the system for generating the network related output of the eleventh aspect or any other aspect, the processor is configured to determine whether to add or remove the specific network constituent from the approved network list using the plurality of classification values by: comparing the plurality of classification values to respective threshold values; determining whether the specific network constituent is presently included in the approved network list; removing the specific network constituent from the approved network list when the specific network constituent is determined to be presently included in the approved network list and one or more of the plurality of classification values are below the respective threshold values; adding the specific network constituent to the approved network list when the specific network constituent fails to be determined to be presently included in the approved network list and each of the plurality of classification values are above the respective threshold values.

In a thirteenth aspect of the system for generating the network related output of the eleventh aspect or any other aspect, the processor is configured to add or remove the specific network constituent from the approved network list using the plurality of classification values by: inputting the plurality of classification values into a trained network constituent approval model; and receiving a directive to add or remove the specific network constituent from the approved network list as an output of the trained network constituent approval model.

In a fourteenth aspect of the system for generating the network related output of the eleventh aspect or any other aspect, the processor is further configured to train the trained network constituent approval model by iteratively: inputting a plurality of known classification values into the trained network constituent approval model, each of the plurality of known classification values being associated with a known approved or rejected network constituent; comparing an output of the trained network constituent approval model to known approved or rej ected network constituent for the input plurality of known classification values; and updating the trained network constituent approval model based on results of the comparing step.

In a fifteenth aspect of the system for generating the network related output of the eleventh aspect or any other aspect, the processor is further configured to: retrieve proprietary bulk data from proprietary data sources and non-proprietary bulk data from non-proprietary data sources; and transform the proprietary bulk data and the non-proprietary bulk data into the plurality of network information training data sets according to preconfigured classification guidelines.

In a sixteenth aspect of the system for generating the network related output of the fifteenth aspect or any other aspect, the proprietary bulk data includes internal reporting on a plurality of network constituents, wherein the non-proprietary data includes self-reporting on the plurality of network constituents from each of the plurality of network constituents.

In a seventeenth aspect of the system for generating the network related output of the eleventh aspect or any other aspect, the plurality of data types include network metrics relating to at least one of quality, participation, speed, and cost.

In an eighteenth aspect of the system for generating the network related output of the eleventh aspect or any other aspect, wherein the processor is further configured to: compile an updated plurality of network information training data sets corresponding to each of the plurality of data types, each of the updated plurality of network information training data sets having a respective updated known classification value; retrain the plurality of trained training modules with the updated plurality of network information training data sets by iteratively: inputting each of the updated plurality of network information training data sets into the plurality of trained training modules based on the respective one of the plurality of data types thereof; comparing outputs of the plurality of trained training modules to the respective updated known classification value for the input ones of the updated plurality of network information training data sets; and updating the one or more emphasis guidelines for the respective plurality of nodes of the plurality of trained training modules based on results of the comparing step.

In a nineteenth aspect of the system for generating the network related output of the eleventh aspect or any other aspect, the processor is further configured to: after modifying the display, receive changes to the plurality of input network information data sets; process the changes to the plurality of input network information data sets with the trained training module to generate an updated plurality of classification values; and modify the display based on the updated plurality of classification values.

In a twentieth aspect of the system for generating the network related output of the eleventh aspect or any other aspect, the processor is further configured to: generate a plurality of graphical user interface displays that include the plurality of classification values; receive user input on at least one of the plurality of graphical user interface displays, the user input modifying the plurality of input network information data sets; process the plurality of input network information data sets as modified with the trained training module to generate an updated plurality of classification values; and generate the updated plurality of classification values on the plurality of graphical user interface displays.

These and other aspects, features, and benefits of the systems and processes described herein will become apparent from the following detailed written description taken in conjunction with the following drawings, although variations and modifications thereto may be affected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a system for iteratively training a network training module according to embodiments of the present disclosure.

FIG. 2 is a flow diagram of a process for iteratively training a network training module according to embodiments of the present disclosure.

FIG. 3 is a flow diagram of a process for iteratively training a raw training module according to embodiments of the present disclosure.

FIG. 4 is a flow diagram of a process for comparing specific network constituents and updating a network list according to outputs of the trained training module according to embodiments of the present disclosure.

FIG. 5 illustrates a diagram of a plurality of inputs, outputs, and feedback loops used for a process of iteratively training a network training module according to embodiments of the present disclosure.

FIG. 6 illustrates a graphical interface display showing a network recommendation profile visualization according to embodiments of the present disclosure.

FIG. 7 illustrates a graphical interface display showing a network recommendation summary comparison according to embodiments of the present disclosure.

FIG. 8 illustrates a graphical interface display showing a network recommendation summary comparison according to embodiments of the present disclosure.

FIG. 9 illustrates a graphical interface display showing a network recommendation summary comparison according to embodiments of the present disclosure.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Overview

In various embodiments, aspects of the present disclosure generally relate to systems and processes for iteratively training a network training module for providing customized network update recommendations by processing and transforming raw data elements from a plurality of data sources. The system may then use an iteratively trained training module that can be updated and retrained based on updates to bulk data received from a plurality of data sources to provide a network outcome based on updated classification values based on personalized context and intelligence of the training module. Rather than using averaged data based on generic reporting data or subjective information data sets, the system uses a processor to transform data retrieved from a plurality of data sources to generate a training module that outputs a customized network list as determined by a plurality of classification values that can be updated based on specific data types associated with a plurality of network information data sets.

### Description of the Figures

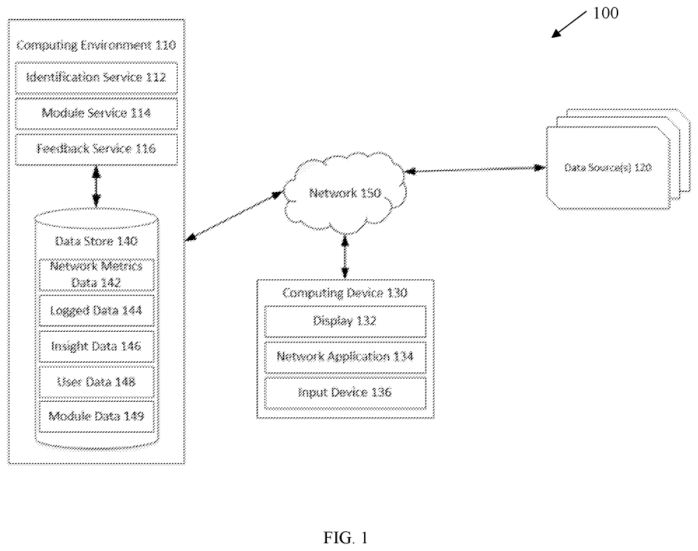

Referring now to the figures, for the purposes of example and explanation of the fundamental processes and components of the disclosed systems and processes, reference is made to FIG. 1, which illustrates a networked environment or system 100 for use in generating the trained network training module as described herein., according to embodiments of the present disclosure. As one skilled in the art will understand and appreciate, the system 100 shown in FIG. 1 (and those of all other flowcharts and sequence diagrams shown and described herein) represents merely one approach or embodiment of the present system, and other aspects are used according to various embodiments of the present system. The steps and processes may operate concurrently and continuously and are generally asynchronous, independent, and are not necessarily performed in the order shown.

FIG. 1 illustrates a networked environment or system 100 for use in generating the trained training module as described herein. In various embodiments, the networked environment 100 includes a network system configured to perform one or more processes for advanced data processing and transforming data into customized network recommendations and network updates based on a plurality of classification values and tunable emphasis guidelines. The networked environment 100 may include, but is not limited to, a computing environment 110, one or more data sources 120, and one or more computing devices 130 that communicate together over a network 150. The network 150 includes, for example, the Internet, intranets, extranets, wide area networks (“WANs”), local area networks (“LANs”), wired networks, wireless networks, or other suitable networks, or any combination of two or more such networks. For example, such networks can include satellite networks, cable networks, Ethernet networks, and other types of networks.

According to some embodiments, the computing environment 110 includes, but is not limited to, an identification service 112, a module service 114, a feedback service 116, and a data store 140. The elements of the computing environment 110 can be provided via a plurality of computing devices 130 that may be arranged, for example, in one or more server banks or computer banks or other arrangements. Such computing devices 130 can be located in a single installation or may be distributed among many different geographical locations. For example, the computing environment 110 can include a plurality of computing devices 130 that together may include a hosted computing resource, a grid computing resource, and/or any other distributed computing arrangement. In some cases, the computing environment 110 can correspond to an elastic computing resource where the allotted capacity of processing, network, storage, or other computing-related resources may vary over time.

In various embodiments, the plurality of data sources 120 generally refers to internal or external systems, databases, or other platforms from which various data is received or collected. In certain embodiments, the plurality of data sources 120 may include either or both of proprietary and non-proprietary data sources. In another example, a data source 120 includes a site for posting open requests from which the computing environment 110 collects and/or receives request information. In another example, a data source 120 includes a request form which the computing environment 110 retrieves attributes, qualifications, and other populated data fields. In one non-limiting example, a request can include a requisition request for a new or lateral candidate. In this example, a requisition request can include a request for candidates for a specific position or seeking candidates with specific attributes or other metrics (i.e., qualification, location, demographic, part-time, contract, etc.).

In one or more embodiments, the system may collect data by a plurality of methods including, but not limited to, initiating requests at data sources (e.g., via an application programming interface (“API”)), scraping and indexing webpages and other information sources, retrieving data from a data store, and receiving and processing inputs or other uploaded information (e.g., such as an uploaded requests, fulfillment notifications, identification metrics and/or profiles, advertisements, notifications, reports, etc.). In one example, to collect logged data 144, the system receives and processes a set of inputs and uploads from a particular user account with which a specific network constituent is associated. In at least one embodiment, the system receives or retrieves the bulk data from multiple data sources, including but not limited to: U.S. Bureau of Labor Statistics (“BLS”) surveys, job postings, position descriptions, network surveys, anonymized customer data, data partners, social and public networks, as well as collects data directly from websites through, for example, web scraping technology. In certain embodiments, this data may be received as a file, through an API call, scraped directly, or via other mechanisms. Once collected, the bulk data may be then stored in one or more databases or a data lake.

According to various aspects of the present disclosure, the data may then be processed, cleaned, mapped, triangulated, and validated across the various data sources. In one embodiment, the system includes a first Adaptive Taxonomy^{SM} called the “IQ Supplier Optimizer” and uses over 40,000 proprietary and public data sources to create an evergreen, adaptive taxonomy, which provides real-time network mapping. In at least one embodiment, the system syncs constituent-specific taxonomy to the most up-to-date classification values to provide network updates and recommendations via an AI-powered database. In at least this way, the data specific to each network constituent can be collected by the system and tagged based on a plurality of raw data elements so that the data can be further processed and analyzed to provide customized network recommendations, according to the systems and processes described below. When used throughout the present disclosure, one skilled in the art will understand that “network constituent” can include a company, organization, talent supplier, entity, or similar.

The collected bulk data can include a plurality of grouped data entries. In some embodiments, the grouped data entries may include a plurality of raw data elements associated with a specific classification value. The plurality of raw data elements may include, but is not limited to, network metrics data 142, logged data 144, insight data 146, and user data 148, and module data 149. In some embodiments, the grouped data entries may also include a known classification value. When used throughout the present disclosure, one skilled in the art will understand that “classification value” can include a benchmark, a constituent-specific rank, a goal, or specific parameter. When used throughout the present disclosure, one skilled in the art will understand that “position” can include a role, job, or similar and can refer to part-time, full-time, contract, or other types of arrangements. When used throughout the present disclosure, one skilled in the art will understand that “candidate” can include a current or targeted employee, applicant, contractor, authorized agent, or an individual generally associated with a position.

In at least one embodiment, the system receives or retrieves bulk data including network metrics data 142, which may include but is not limited to: 1) industry; 2) diversity; 3) size, including, but is not limited to, number of requests processed; 4) age; 5) validation information; 6) retention rate(s); 7) location; 8) resources; 9) communication; and 10) renumeration packages. When used throughout the present disclosure, one skilled in the art will understand that “renumeration” can include rate, salary, pay, compensation, benefits, or a combination of these.

In some embodiments, the system receives or retrieves bulk data including logged data 144, which can include but is not limited to: 1) historical data; 2) profile provided by network constituents; 3) profiles provided by other data sources 120; 4) surveys; and 5) a plurality of different types of reports and reporting tools.

According to particular embodiments, the system receives or retrieves insight data 146, which can include, but is not limited to: 1) current tenure; 2) average tenure for previously fulfilled requests; 3) number of previous requests fulfilled; 4) retention of previous requests; 5) skills and qualifications; 6) supply/demand; 7) average regional trends; 8) diversity within candidate pool; 9) risk monitoring; 10) financial monitoring; and 11) average time to fulfill requests.

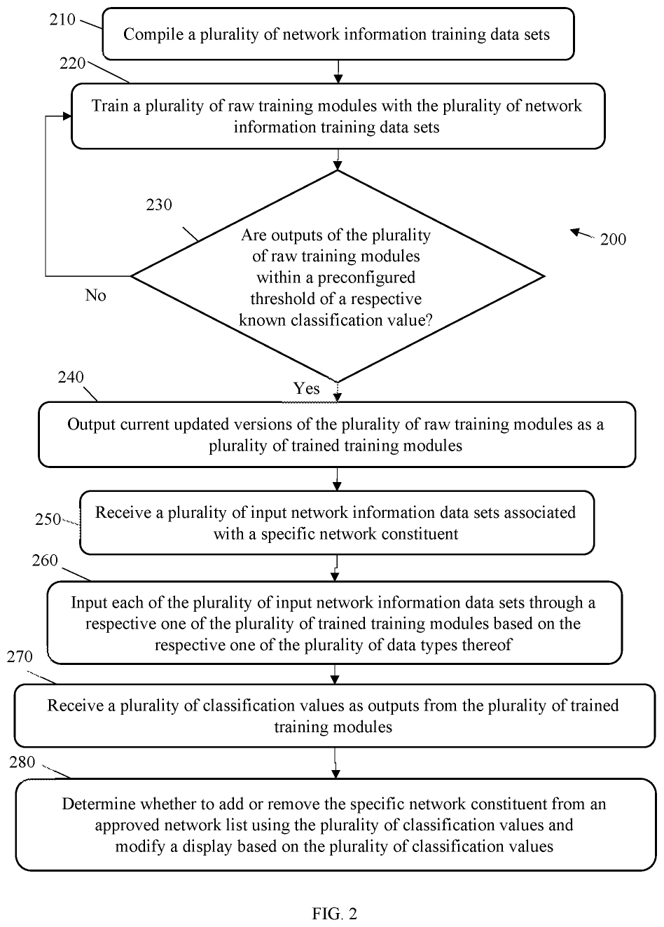

In at least one embodiment, the system can calculate one or more secondary metrics from the collected data. For example, the system can compute, for each request, an estimated demand. To determine an estimated demand, the system can utilize collected data including, but not limited to: 1) position title; 2) position level; 3) statistical data describing actual rates of various people having various position titles; 4) skills; 5) relative rate; 6) education level; 7) geography; 8) unemployment rates; 9) turnover rates; 10) evaluating the number of candidates applied, interviewed, selected, hired, declined; and 11) the number of requests submitted. The system utilizes the processes illustrated in FIGS. 2-4 and described below to transform the collected data into customized network recommendation, in part, on estimated demand and supply statistics from specific network constituents using a network taxonomy. In one embodiment, the network taxonomy includes real-time request market mapping based on an network constituent's specific classification values, including but not limited to: participation, quality, speed, and cost. The network training module utilizes a series of emphasis guidelines to further process and filter the estimated demand based on different requests, and known classification values specific to the network constituent, along with other factors, to provide an recommended network to fulfill requests efficiently and effectively. When used throughout the present disclosure, one skilled in the art will understand that “emphasis guidelines” can include weights, ranks, or other similar factors or variables of varying levels of significance based on the specific metric being analyzed by the training module. For example, in some embodiments, the emphasis guidelines as described herein can include weights, ranks, or the like assigned to a plurality of connections between a plurality of nodes of a training module as described herein.

The identification service 112 can be configured to request, retrieve, and/or process data from a plurality of data sources 120. The identification service 112 can be further configured to map raw data elements with specific network constituents. In one example, the identification service 112 is configured to automatically and periodically (e.g., daily, every 3 days, 2 weeks, etc.) collect information from a plurality of databases including both open and filled requests. In another example, the identification service 112 is configured to request and receive a list of required and/or preferred attributes and/or metrics from individual records or open requests. In another example, the identification service 112 can be configured to monitor for changes to various information at a data source 120. In one example, the identification service 112 monitors for new requests or for an updated status to a previously fulfilled request. In this example, the identification service 112 detects that a new request, or group of requests, has been generated and extracts the data associated with the request(s), including but not limited to: the required or preferred skills, entity and diversity goals, position title, and classification value(s) associated with a particular request or entity. The identification service 112 can further map the extracted data the identity of the requester, along with the classification value associated with the different data elements. In another example, the identification service 112 can detect if a previously fulfilled request changes status, as this may indicate, in one non-limiting example, that the previously filled request was not an appropriate match. In this example, the identification service 112 can further extract data associated with the previous request to identify the time period and circumstances surrounding the previous request placement and subsequent departure. Continuing this example, in response to the determination, the identification service 112 automatically collects the new request information, which may be stored in the data store 140. The identification service 112 can perform various data analysis, modifications, or transformation to the various information. The identification service 112 can determine likely categories or bins for various data for each request. As an example, the identification service 112 can determine a specific request is associated with an in-demand position at a highly valued network constituent with a favorable 5D profile, and that diverse candidates are typically placed with low turnover.

The module service 114 can be configured to perform various data analysis and modeling processes. In one example, the module service 114 generates and iteratively trains training modules for providing dynamic network recommendations. For example, in some embodiments the module service 114 can be configured to perform one or more of the various steps of the processes 200, 300, and 400 shown and described in connection with FIGS. 2-4. The module service 114 can be configured to generate, train, and execute a plurality of nodes, neural networks, gradient boosting algorithms, mutual information classifiers, random forest classifications, and other machine learning and artificial intelligence related algorithms.

The module service 114 or identification service 112 or feedback service 116 can be configured to perform various data processing and transformation techniques to generate input data for training modules and other analytical processes. For example, in some embodiments, the module service 114 or the identification service 112 or feedback service 116 can be configured to perform one or more of the data processing and transformation steps of the processes 200, 300, and 400 shown and described in connection with FIGS. 2-4. Non-limiting examples of data processing techniques include, but are not limited to, network resolution, imputation, and missing or null value removal. In one example, the module service 114 performs network resolution on identification data for a plurality of requests to standardize terms such as potential individuals, required/preferred attributes, education, prior experience, renumeration values, geographic preferences, and other suitable factors. Network resolution may generally include disambiguating manifestations of real-world entities in various records, requests, or mentions by linking and grouping. In one embodiment, a dataset of logged data 144 may include a plurality of open and filled requests for a single network constituent. In one or more embodiments, the system may perform network resolution to identify data items that refer to the same network constituent but may use variations of the request type. In a non-limiting example, a dataset may include references to a position specific data that can then be used in position-based analytics including, but not limited to: filtering, toggling, creating multiple deployment tiers, setting limiting timers, establishing minimum threshold levels for fulling requests, etc.). In one example, position specific data may be categorized based on the position title “Software Developer 3”; however, various data set entries or requests may refer to an equivalent or similar position using terms like engineer, programmer, coder, and qualifying words like advanced, experienced, intermediate, senior, and other variants. In a similar scenario, an embodiment of the system may perform network resolution to identify all dataset entries that include a variation of the identifier's name and replace the identified dataset entries with the standard identification based on the industry. The module service 114 may further utilized logged data 144, including historical data, for various requests to assign known classification values associated with various metrics identified in the logged data 144. As an example, the module service 114 may identify that requests distributed to Entity A correlate with fulfilled requests resulting in long-term, diverse candidates compared to requests fulfilled by Entity A. The module service 114 may also analyze the extracted data with the self-reported data from each constituent, to adjust the classification value(s) of certain requests associated with the identifiers based on the evaluation of similar requests and fulfillment data.

The feedback service 116 can be configured to generate a plurality of feedback loop models to adjust and update the training model(s) and network recommendations based on feedback of at least, but not limited to, the following data: participation data, quality data, speed data, and cost data. As shown in FIG. 1, this data can also be stored and updated in the data store 140, such that the feedback service 116 provides ongoing monitoring and updating based on the feedback loop models. In one embodiment, the feedback service 116 can be used to give personalized network recommendations based on specific network constituent metrics. Additionally, the feedback service 116 can also provide personalized network recommendations based on a plurality of network constituents, based on a specific classification value. In at least one embodiment, the system may generate models, outcomes, predictions, and classifications for network constituents using ensemble models that combine aggregate impacts of the candidates, positions, associated skillsets, renumeration, diversity, turnover, fulfillment rates, and other factors that make up each network constituent profile as well as models that generate classification-specific and location-specific taxonomies, as two non-limiting examples. In one embodiment, the system may utilize and integrate with the retention score model system described in U.S. patent application Ser. No. 16/549,849 filed Aug. 21, 2019, entitled “MACHINE LEARNING SYSTEMS FOR PREDICTIVE TARGETING AND ENGAGEMENT,” (“the '849 Application”), which is incorporated herein by reference in its entirety. The system goes beyond statistical averages and identifies a requisition-specific network recommendations based on the specific classification value(s) needed to appropriately fulfill a request. In some embodiments, the feedback service 116 can leverage training module processes (e.g., via the module service 114) to generate network recommendations that are optimized to increase a likelihood of successful long-term fulfillment, minimize costs and risk, and meet the one or more classification values for a specific request. In some embodiments, the feedback service 116 customizes a network recommendation based on network metrics data 142 with which a particular request is associated and/or logged data 144 or insight data 146 with which a request is associated.

The data store 140 can store various data that is accessible to the various elements of the computing environment 110. In some embodiments, data (or a subset of data) stored in the data store 140 is accessible to the computing device 130 and one or more external system (e.g., on a secured and/or permissioned basis), including at least the feedback service 116 as described above. Data stored at the data store 140 can include, but is not limited to, network metrics data 142, logged data 144, insight data 146, user data 148, and module data 149. The data store 140 can be representative of a plurality of data stores 140 as can be appreciated. The network metrics data 142, the logged data 144, and the insight data 146 include, at least, the information within the collected bulk data associated with each type of data.

The user data 148 can include information associated with one or more users. For example, for a particular user, the user data 148 can include, but is not limited to, an identifier, user credentials, and settings and preferences for controlling the look, feel, and function of various processes discussed herein. User credentials can include, for example, a username and password, biometric information, such as a facial or fingerprint image, or public/private keys. Settings can include, for example, communication mode settings, alert settings, schedules for performing iterative training of training modules and/or recommendation generation processes, and settings for controlling which of a plurality of potential data sources 120 are leveraged to perform training module processes.

In one example, the settings include standardized data element groups for a particular position location or region. In this example, when the data inputs are filtered to a particular region, a training module output can be adjusted to provide more or less emphasis for a cost of living, culture, or other factors with which the particular region is associated. Various regions and sub-regions of the world may demonstrate varying cultures and expectations related to classification values. Likewise, these varying classification values can be regional to specific network constituents and contribute to concentrated areas of specific demographics, which may be factored into the network metric data 142, logged data 144, or insight data 146 for specific network constituents. These variances may impact the emphasis of specific guidelines imposed on a plurality of nodes within the iterative training process for generating trained training modules in order to update the training module to output accurate and appropriate recommendations. For example, the system may alter one or more emphasis guidelines to reduce an impact or change impact certain classification values. In the above example, the system may reduce emphasis guidelines on a plurality of nodes and/or modify emphasis guidelines on a plurality of nodes including the emphasis of classification values like, for example, specific skills, geographic location, demographic, or position type, thereby modifying the guideline's emphasis and impact on subsequently generated network recommendations as the training module is iteratively trained.

The module data 149 can include data associated with iteratively training of the training modules and other modeling processes described herein. Non-limiting examples of module data 149 include, but are not limited to, machine learning techniques, parameters, guidelines, emphasis values (e.g., weight values), input and output datasets, training datasets, validation sets, configuration properties, and other settings. In one example, module data 149 includes a training dataset including historical network metrics data 142, logged data 144, and insight data 146. In this example, the training dataset can be used for training a training module to provide a network recommendation based on a specific classification value. For example, if a request is submitted for a diverse executive with six years experience as an executive at a publicly traded entity, the training dataset may place more weight on the classification value(s) related to diversity, experience, and entity size, rather than geographic location or education. In this example, the system can then provide a network recommendation for a specific network constituent, or a plurality of specific network constituents, based on the specific request in light of the classification value(s) identified.

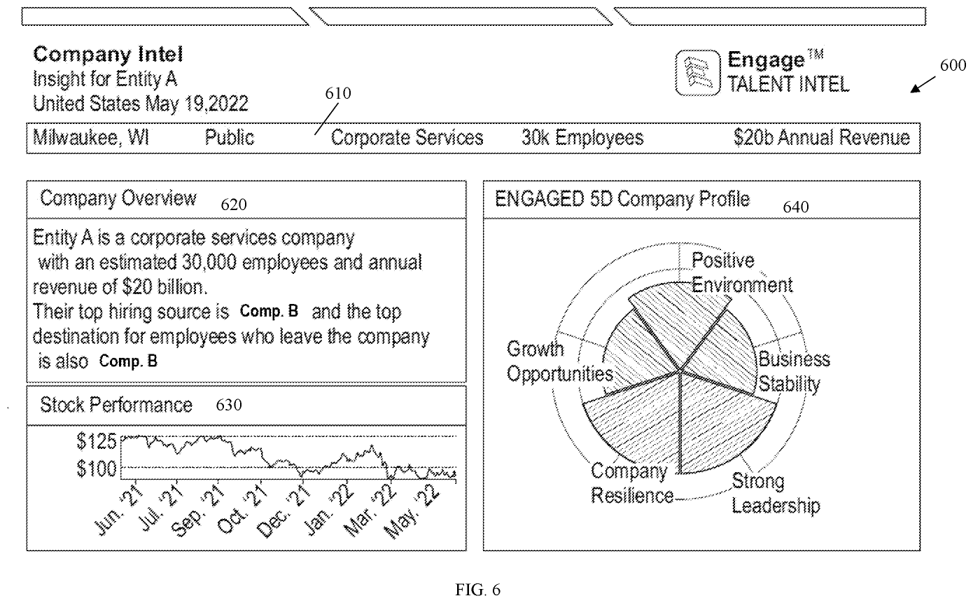

The computing device 130 can be any network-capable device including, but not limited to, smartphones, computers, smart accessories, such as a smart watch, key fobs, and other external devices. The computing device 130 can include a processor and memory. The computing device 130 can include a display 132 on which various user interfaces can be rendered by a network application 134 to configure, monitor, and control various functions of the networked environment 100. For example, in some embodiments the computing device 130 can be configured to perform one or more of the modifying display steps of the processes 200, 300, and 400 shown and described in connection with FIGS. 2-4. Additionally, the output display modified by the system in one or more steps of the processes 200, 300, and 400 can include the display interface illustrations 600, 700, 800, and 900 for FIGS. 6-9, for example. The network application 134 can by executed on the computing device 130 and can display information associated with processes of the networked environment 100 and/or data stored thereby. In one example, the network application 134 displays network recommendations and specific network constituent profiles that are generated or retrieved from user data 148.

The computing device 130 can include an input device 136 for providing inputs, such as requests and commands, to the computing device 130. The input device 136 can include one or more of a keyboard, mouse, pointer, touch screen, speaker for voice commands, camera or light sensing device to reach motions or gestures, or other input device 136. The network application 134 can process the inputs and transmit commands, requests, or responses to the computing environment 110 or one or more data sources 120. According to some embodiments, functionality of the network application 134 is determined based on a particular user or other user data 148 with which the computing device 130 is associated. In one example, a computing device 130 is associated with a user and the network application 134 is configured to display network recommendations based on geographic locations, including but not limited to both network constituent profiles and request profiles or reports. A user can use the input device 136 to modify classification values, for example to exclude certain required skills, filter to a specific geographic region, or select a preferred gender for the candidate. The input from the input device 136 is transmitted or otherwise communicated with the computing environment 110 to update the network recommendation output, which is communicated to the computing device 130, which modifies the display 132 to include the updated network recommendation based on the specific classification values selected or deselected by the user. In at least this way, the system and process for training the training module of the present disclosure transforms raw data elements to provide a customized recommendation that can be further modified and adjusted using tunable emphasis guidelines based on request-specific classification values and user input.

FIG. 2 illustrates a training process 200 for iteratively training a network training module to provide network recommendations based on classification values, according to embodiments of the present disclosure. At step 210, the system retrieves bulk data from a plurality of data sources and compiles the data into a plurality of network information training sets. Non-limiting examples of the plurality of data sources 120 include, but are not limited to, the proprietary and non-proprietary examples provided in the description of FIG. 1. In at least one embodiment, the present system may automatically or manually (e.g., in response to input) collect, retrieve, or access data including, but not limited to, network metrics data 142, logged data 144, insight data 146, user data 148, or module data 149, as described in relation to FIG. 1.

Additionally at step 210, the system can compile the bulk data into a plurality of network information training sets by transforming raw data elements within the bulk data into standardized data element groups based on different classification values and by data type(s). When used throughout the present disclosure, one skilled in the art will understand that “transform” can include normalize, standardize, and other advanced analysis techniques for manipulating the data such that it can be processes, analyzed, and used to generate customized recommendation outputs according to the present disclosure. In at least one embodiment, the data transformation can include one or more data modifications such as: 1) imputing missing data; 2) converting data to one or more formats (e.g., for example, converting string data to numeric data); 3) removing extra characters; 4) formatting data to a specific case (e.g., for example, converting all uppercase characters to lowercase characters); 5) normalizing data formats; and 6) anonymizing data elements.

In various embodiments, the system may also perform network resolution on the collected data (e.g., prior to, or after, other data processing and transformation steps). In these embodiments (and others), the bulk data is transformed into network information training data sets. To transform the bulk data into network information training data sets, the system may assign classification values to specific data fields using a series of preconfigured keywords and metrics commonly found in the plurality of data sources to generate groups of network information training data sets that can be further analyzed and processed during the iterative training of step 230 described below.

The system also extracts known classification values from the bulk data. The extraction may be performed through one or more data processing techniques, including but not limited to, performing text recognition, data transformation, text mining, and information extraction. In one embodiment, the system may use data processing and extraction techniques described at step 254 of U.S. patent application Ser. No. 17/063,263 filed Oct. 5, 2020, entitled “MACHINE LEARNING SYSTEMS AND METHODS FOR PREDICTIVE ENGAGEMENT,” (“the '263 Application”), which is incorporated herein by reference in its entirety. The extracted known classification values can be mapped to specific network constituents using the identification service 112, as described in relation to FIG. 1.

In at least one embodiment, the system evaluates completeness of collected data. For example, the system may determine a magnitude of missing data in a collected data set, and based on the magnitude, can calculate a “completeness” score. The system can include a “completeness” threshold and can compare completeness scores to the completeness threshold. In one or more embodiments, if the system determines that a data set's completeness score does not satisfy a completeness threshold, the system can exclude the data from being compiled into a network information training set and exclude that particular data set from further evaluation. By evaluating and filtering for completeness, the system may exclude data sets that are intolerably data deficient (e.g., and which may deleteriously impact further analytical processes).

At step 220, the system compiles (or retrieves from a database) a network information training data set including a known classification values that is used to iteratively train one or more raw training modules to create a plurality of trained training module. In one example, the system can input a network information training data set into a raw training based on the data type of the bulk data. In one non-limiting example, this allows the system to iteratively train the training models based on a plurality of input data sets of different data types, including data provided by specific network constituents (like self-reported profiles and statistics) and objective network metrics data 142 and logged data 144.

At step 230, the output can then be compared to the known classification value(s) for the input network information data set. The one or more emphasis guidelines of the system can be updated for a plurality of nodes within the raw training modules based on the results of the comparing step, in order to iteratively train and improve the training module.

At step 240, when the output of the raw training module(s) is within a preconfigured threshold of the known classification values for the input network information training data sets, as determined during the compare step of 230, the plurality of raw training modules are output as trained training modules.

The system in step 250, can receive and process a plurality of input network information data sets associated with a specific network constituent, wherein each of the plurality of input network information data sets have a plurality of data types. In one embodiment, a specific network constituent may have multiple associated input network information data sets. In step 260, the system can input each of the plurality of input network information data sets through a trained training module based on the data type.

The system, in step 270, receives a plurality of classification values as outputs from the plurality of trained training modules. In at least this way, system can utilize a plurality of trained training modules to output specific recommendations tailored to certain classification values. In one example, if a request has a classification value based on cost, the system can using a training module based primarily on the classification value of cost. Alternatively, the system could also utilize a combination of multiple training modules where cost is one of a plurality of classification values. Additionally, the system could adjust the tunable emphasis guidelines of any of the training modules or a combination of a plurality of training modules, to focus on the cost-based classification value. The system, in this example, uses the trained training module(s) to evaluate the request based on a classification value associated with a specific network constituent compared to the network average, along with the mechanisms for the adaptive feedback loop modules using the feedback service 116, described in connection with FIG. 1, to provide a network recommendation for one or more specific network constituents based on the classification value of cost. It will be appreciated by one skilled in the art that a combination of multiple classification values can be used in a single evaluation to provide a customized network recommendation based on a high level of certainty.

In step 280, the system determines a network recommendation based on the classification value(s) and modifies a display based on the network recommendation(s), including but not limited to, interactive interface graphics as seen in FIGS. 6-9. As described above in connection with FIG. 1, the steps 250-280 may be performed by an identification service 112, a module service 114, a feedback service 116, or a combination of any of these.

Additionally, in some embodiments, the training module can be trained using the machine learning training system of the '263 Application or the analysis engine described in the '849 Application. In one example, the system can be trained using a modification of Equation 1 and Equation 2 of the '263 Application, wherein the modification includes a vector of characteristics for a request, including classification values, rather than just the candidate.

Also, the system can include one or more secondary metrics as parameters in one or more processes to iteratively train a training module or a plurality of training modules (as described herein). When used throughout the present disclosure, one skilled in the art will understand that processes for “iteratively training the training module” can include machine learning processes, artificial intelligence processes, and other similar advanced machine learning processes. For example, the system and processes of the present disclosure can calculate estimated market demands for a plurality of requests and can leverage the estimated demands as an input to an iterative training process for a network recommendation based on a plurality of tunable emphasis guidelines and adjustable classification values.

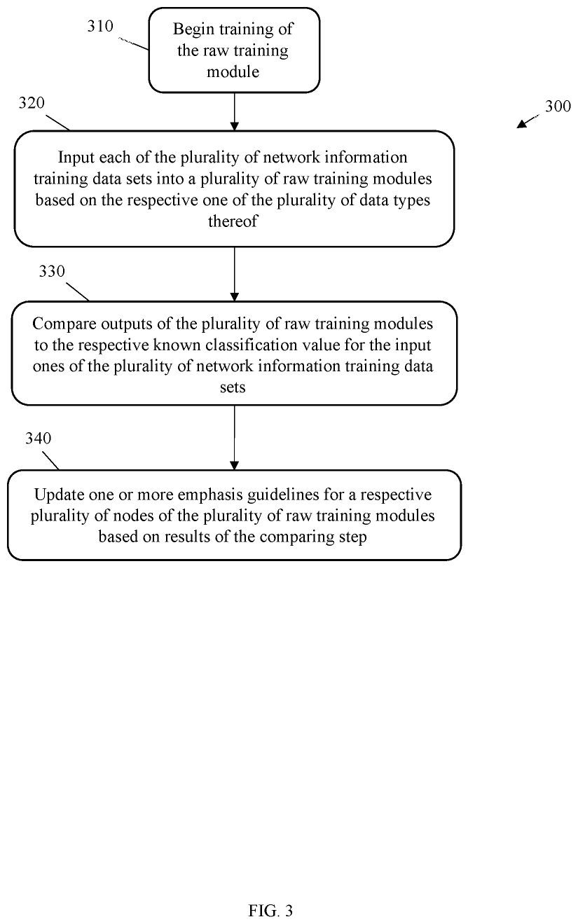

FIG. 3 illustrates a training process 300 for iteratively training the one or more raw training modules, as shown in step 230 of FIG. 2. At step 310, the system begins to iteratively train the one or more raw training modules. For example, the system can generate a first version of the training module. The first version training module, in step 320, can process each of the plurality of network information data sets, using known parameters and classification values, to generate a set of training outcomes (e.g., respective output classification values). In one embodiment, the system may utilize the module service 114, and/or feedback service 116 described in connection with FIG. 1, to perform various data analysis and modeling processes, including the generation and training of the first version of the training module in step 310 and for generating a network recommendation, including various components of a classification value based on request-specific factors and data types in step 320.

At step 330, the system can compare the set of training outcomes from each of the plurality of network information training data sets to the training set of known classification values associated therewith and can calculate one or more error metrics between the respective output classification value and the known classification values. In at least one embodiment, the system may generate models, outcomes, predictions, and classifications for individuals (including job security, and propensity to change positions), entities (including talent retention risk, churn predictions, competitive risk analysis compared to industry standards, and identification of talent inflows and outflows), industries (including talent retention risk, voluntary churn rates, and JOLTS job opening survey predictions), and economies (including market performance predictions and unemployment rate predictions) using ensemble models that combine aggregate impacts of the classification values and associated talent resources that make up each specific network constituent as well as models that generate network or request-specific scoring methodologies. In at least this way, the system creates the plurality of network information training data sets used to compare, at step 330, to the set of training outcomes. For example, the system may generate an aggregated model, outcomes, predictions, and classifications values for a request for a new executive from a specific network constituent. The aggregated model, outcomes, predictions, and classification may assist the entity in determining appropriate network constituent to utilize in order to minimize costs and maximize the possibility of obtaining a qualified candidate with minimal effort. The system can also provide recommended renumeration packages based on estimated demands based on the request-specific classification values.

During the compare step 330, the system also determines if the output classification value falls within a preconfigured threshold amount of the known classification value associated with the plurality of raw training modules. In one example, if the training module determines a recommended classification value for speed, or time it takes to fulfill a request after being issued, for a specific network constituent hired by Entity A, and that recommended classification value is above or below a threshold percentage of what Entity A has historically identified as the speed for fulfilling requests from this specific network constituent, the system would identify this discrepancy at step 440 and make modifications to the one or more emphasis guidelines. Otherwise, if the recommended classification value is within the threshold percentage, the raw training module is updated according to step 340. In some embodiments, there may be multiple classification values that contribute to a network recommendation, including but not limited to participation, quality, speed, and cost. The classification value of participation can include, but is not limited to, the number of requisitions accepted, the number of requisitions declined, and the amount of requisitions actually hired who performed work.

The classification value of quality can include, but is not limited to, the number of candidates hired, the number of candidates declined, the number of quality resources, the demographic of the talent pool, the turnover rate (both voluntary and involuntary), and a supervisor satisfaction quality rating. The classification value of speed can include, but is not limited to, the number of days to receive a qualified submittal after submitting a request, and the days to fulfill a request with a qualified candidate or plurality of candidates. The classification value of cost may include, but is not limited to, the number of candidates hired above the maximum threshold rate provided in the request, the number of candidates hired above the target rate provided in the request, and the financial data related to competitive analytics. In at least one embodiment, the classification values of participate, quality, speed, and cost can be incorporated into the feedback service 116, described in FIG. 1. The system can also be retrained to analyze a plurality of the one or more emphasis guidelines in the retraining process to accommodate for these different classification values, even if the system outputs a classification value within the preconfigured threshold amount.

If yes, at step 340, the system outputs or updates the raw training module as the trained training module. In one embodiment, the module service 114 can further be configured to generate, train, and execute neural networks, gradient boosting algorithms, mutual information classifiers, random forest classifications, and other machine learning and related algorithms in order to complete at least steps 320-340.

If no, at step 340, the system may update one or more raw emphasis guidelines for a first plurality of nodes of the raw training module, such that the raw emphasis guidelines are updated based on analysis of the comparing step 330. The system can iteratively retrain the raw training module by repeating the process 300 with the updated one or more emphasis guidelines. For example, if emphasis guidelines related to or associated with a specific skillset are significantly contributing to returning a network recommendation above the classification value for cost associated with that specific skillset in that position, the system can increase or decrease the emphasis guideline related to that skillset and retrain the model. Additional examples of the one or more emphasis guidelines and classification values are provided in connection with the description for FIG. 1.

The system can further be used to iteratively optimize the first version training module into one or more secondary version training modules by: 1) calculating and assigning an emphasis (e.g., weights) to each of the known network information training data sets (e.g., parameters or derivatives thereof); 2) generating one or more additional training modules that generate one or more additional sets of training module outcomes; 3) comparing the one or more additional sets of training module outcomes to the known outcomes; 4) re-calculating the one or more error metrics; 5) re-calculating and re-assigning emphasis to each of the emphasis guidelines to further minimize the one or more error metrics; 6) generating additional training modules and training module outcomes, and repeating the process. In at least one embodiment, the system can combine one or more raw training modules to generate a trained training module. The system can iteratively repeat steps 310-340, thereby continuously training and/or combining the one or more raw training modules until a particular training module demonstrates one or more error metrics below a predefined threshold for a particular classification value, or demonstrates an accuracy and/or precision at or above one or more predefined thresholds.

In various embodiments, the system may continuously and/or automatically monitor data sources for changes in position data and other information. In at least one embodiment, the system can be configured to monitor changes to the data sources by a plurality of data monitoring techniques, including but not limited to: web scraping, receiving push updates or notifications from a plurality of data sources, analyzing information and reports, or a combination of any of these. The system can be further configured to perform various data analysis, modifications, or normalizations to the various information in order to determine which information is new or has been changed compared to the information previously received or retrieved. In some embodiments, the identification service 112, described in connection with FIG. 1, can be used to perform some or all of the steps of the data monitoring process. In at least one embodiment, upon detecting a change in position data or other information, the system may perform actions including, but not limited to, automatically collecting, storing, and organizing the updated position data or other information, generating and/or transmitting one or more notifications if preconfigured to indicate an update to the data. The updated data can also be used to retrain one or more training modules to generate updated recommendations, including the processes 200 and 300 described in connection with FIG. 2 and FIG. 3.

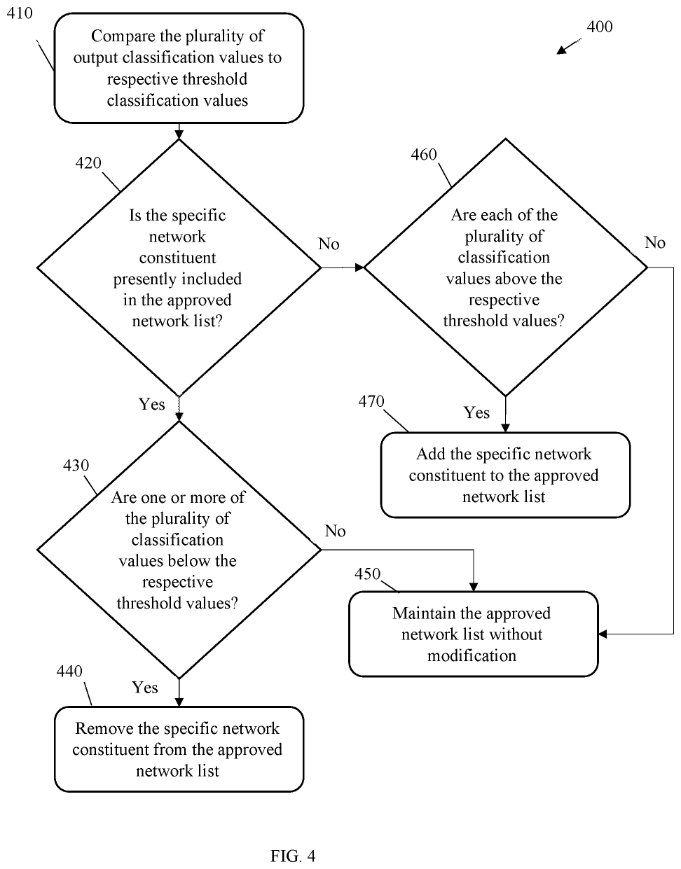

FIG. 4 illustrates a process 400 for updating a network list to provide customized network updates and recommendations as the network training module is iteratively retrained as bulk data is updated and/or the feedback loop modules of the feedback service 116 integrate with the system for iteratively retraining the trained training modules. At step 410, the system compares the plurality of output classification values to respective threshold classification values. As described above, there can be multiple classification values associated with a specific network constituent. In some embodiments, the system can use advanced analytics to compare a plurality of classification values to provide a customized output based on the specific request and/or classification value(s). The system also identifies the specific network constituent associated with an output classification value using the identification service 112, described in connection with FIG. 1.

At step 420, the system determines if the specific network constituent related to the output classification value is on an approved network list. If no, the system at step 460 determines if the output classification value(s) are above the respective threshold classification values. If yes, at step 470 the system updates the network recommendation to add the specific network constituent to the approved network list for at least that classification value. If no, at step 450 the system maintains the current network recommendation and does not update the approved network list to include the specific network constituent. If, during step 420, the specific network constituent is determined to already be on the approved network list, the system compares, in step 430, the one or more output classification values to the threshold classification values. If the output classification values are above the threshold values, the network recommendation maintains the specific network constituent on the approved vendor list in step 450. If the output classification values are below the threshold value, the system updates the network recommendation in step 440 by removing the specific network constituent from the approved network list.

In one or more embodiments, the system can identify updated network recommendations based on classification values by evaluating and processing the updated data via one or more trained training modules. The system can modify the display based on the updated network recommendation and/or classification value(s), including but not limited to, interactive interface graphics as seen in FIGS. 6-9.

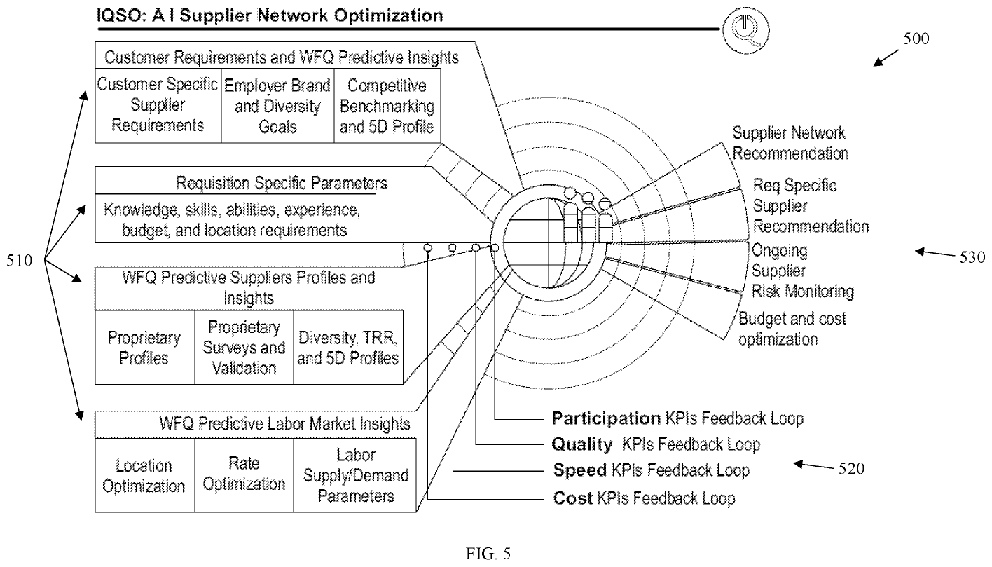

FIG. 5 illustrates a diagram 500 of a plurality of inputs 510, outputs 530, and feedback loops 520 used for a process of iteratively training a network training module according to embodiments of the present disclosure. The diagram 500 may represent components of a process including, but not limited to, the processes 200, 300, and 400 described in connection with FIGS. 2-4. The inputs 510 shown in the diagram 500 may include, but are not limited to, network metrics data 142, logged data 144, insight data 146, user data 148, and module data 149, as shown in FIG. 1. As described in connection with FIG. 1, the feedback loops 520 can be integrated with, or used as the feedback service 116 to generate input data for one or more training modules and can also be configured to perform one or more of the data processing and transformation steps of the processes 200, 300, and 400 shown and described in connection with FIGS. 2-4. The outputs 530 may include customized recommendations for specific network constituents based on a particular request, or can provide an averaged or normalized recommendation based on a batch of requests or historical trend data. The one or more system outputs 530 can further include recommendations for updating an approved network list based on the specific network constituent recommendations. FIG. 5 provides specific data elements and data types as non-limiting examples of these system inputs 510, outputs 530, and feedback loops 520. Additional data elements and data types are possible and can be used to drive customized network outputs.

FIG. 6 is an illustration of a display interface 600 that may be generated on a display device such as the display 132 and updated by the system and processes described in the present disclosure. The display interface 600 may include, but is not limited to, customized profile visualizations for a specific network constituent. The interface 600 can include constituent-specific information 610 including the entity size, type, geographic location or region, industry, financial metrics, and other network metrics data 142. The display interface 600 can be customized and updated to display information relevant to a particular user, but can be configured to provide additional constituent details, like an overview 620 that can include top competitor information, historical stock performance 630 and other logged data 144, an constituent's 5D profile and other insight data 146, and other relevant information. It will be recognized by one skilled in the art that the display interface 600 contains a plurality of customized display options, although FIG. 6 only represents one of many embodiments.

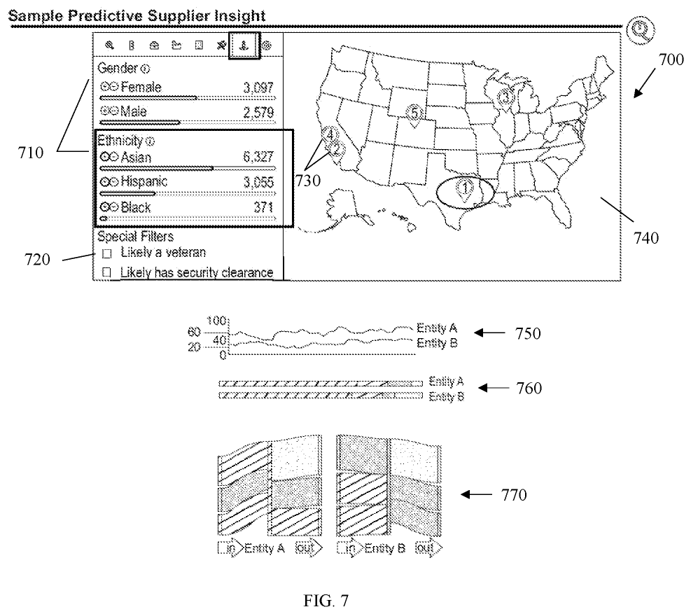

FIG. 7 is an illustration of a display interface 700 that may be generated on a display device such as the display 132 and updated by the system and processes described in the present disclosure. The display interface 700 may include, but is not limited to, a dynamic research analysis metrics-based comparison of the one or more outcomes of the trained training module process described herein. For example, the display interface 700 includes a recommended specific network constituent 740 based on one or more classification values 710, including recommended geographic regions of possible locations of interest 730, based on a concentration of identified candidates according to the specific parameters of a particular requisition. For example, the recommendation in FIG. 7 includes a geographic visualization of the location of diverse candidates as identified by three races and gender, wherein race and gender was one of the classification values 710 considered for this specific position. While the specific constituent recommendation may also include one or more adjustable metrics 720 or filters to adjust the outcome according to desired classification value(s). Additionally, this display interface 700 includes visual indication of a comparison between the top two specific network constituents according to the outcome of the trained training module(s) based on these specific classification values 710. For example, the display interface 700 provides a timeline 750 for average churn time for both Entity A and Entity B, where the left side of the timeline 750 represents the average number of days before churn. Similarly, the chart 760 provides another means for evaluating turnover by evaluating the likelihood of a particular employee to engage with a recruiter. In the examples provided by the timeline 750 and chart 760 for these particular entities, it appears that Entity A was selected as the overall recommended network constituent due, in part, to a lower churn rate (more days between churn cycles in timeline 750) and a lower total number of employees likely or very likely to engage (as represented by the two rightmost bars in 760). Finally, a customized visual representation is provided of a flow diagram 770 of employees hired versus employees leaving, as categorized by the entity they are coming from/leaving to. In this flow diagram 770, each pattern represents a different rate at which employees are hired/leaving for each entity. In this way, the diagram 770 may help teams make intelligent decisions based on where to focus recruiting attentions, as well as areas that recruiting resources could be spared and/or retention efforts could be increased. It will be appreciated by one skilled in the art that once a user has edited the characteristic values 710 or manually selected one or more filters 720, that the system and processes described in the present disclosure can automatically update the display recommendation and associated research analysis metrics according to the updated training module outcomes.

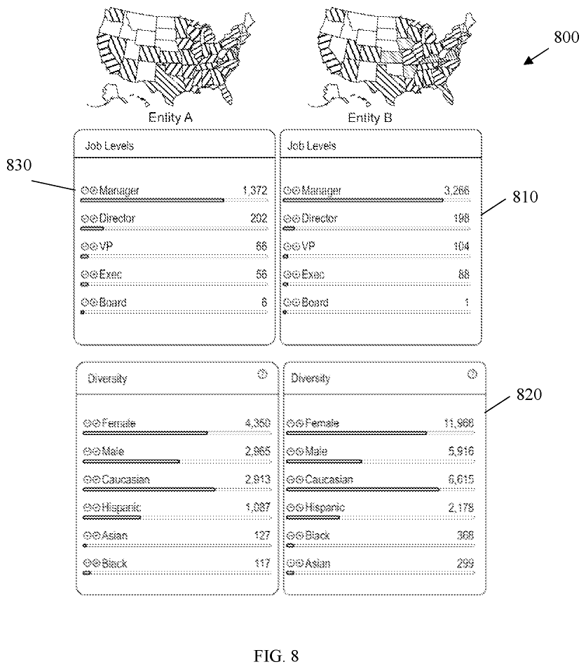

FIG. 8 is an illustration of a display interface 800 that may be generated on a display device such as the display 132 and updated by the system and processes described in the present disclosure. The display interface 800 may include, but is not limited to, a dynamic research analysis metrics-based comparison of the one or more outcomes of the trained training module process described herein. The display interface 800 may include, but is not limited to, a direct comparison and visual representation of the geographic distribution of different position levels 810. The display interface 800 may further include additional classification values 820, like diversity statistics as shown in FIG. 8. The display interface 800 can be further customized and the displayed analytics dynamically updated as a user edits the specific positions 810 or classification values 820. These interactive icons 830 can be customized for a plurality of different classification values 820 and requisite parameters, including specific geographic regions. It will be appreciated by those skilled in the art that the customizable display interface 800 is not limited to the United States or the specific characteristics shown as an example in FIG. 8.

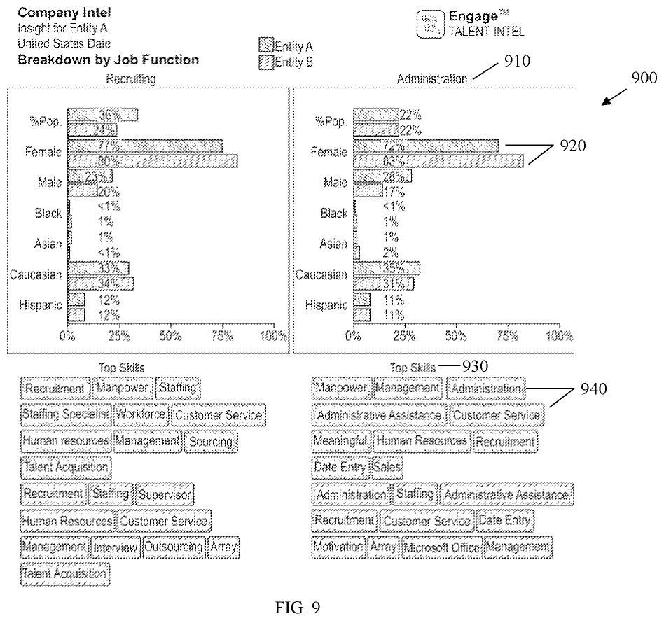

FIG. 9 is an illustration of a display interface 900 that may be generated on a display device such as the display 132 and updated by the system and processes described in the present disclosure. The display interface 900 may include, but is not limited to, a dynamic research analysis metrics-based comparison of the one or more outcomes of the trained training module process described herein. The display interface 900 may include, but is not limited to, a direct comparison and visual representation of the diversity characteristics for different position levels 910 between two or more entities. The display interface 900 may further include additional classification values 920, like education levels, years of experience, renumeration values, or the diversity statistics as shown in FIG. 9. The display interface 900 can be further customized and be configured to dynamically update the analytics in response to a user's edits to the specific classification values 920, specific skills 930, or adding/removing specific parameters 940. In some embodiments, the specific parameters 940 are populated as a result of the logged data 144 and the outputs of the trained training modules, as being the top skills relevant to the particular positions 910. It will be appreciated by those skilled in the art that the customizable display interface 900 is not limited to the specific positions 910, classification values 920, or specific parameters 940 shown as an example in FIG. 9.

It will be understood that various aspects of the processes described herein are software processes that execute on computer systems that form parts of the system. Accordingly, it will be understood that various embodiments of the system described herein are generally implemented as specially configured computers including various computer hardware components and, in many cases, significant additional features as compared to conventional or known computers, processes, or the like, as discussed in greater detail herein. Embodiments within the scope of the present disclosure also include computer-readable media for carrying or having computer executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (“SSDs”) or other data storage devices, any type of removable non-volatile memories such as secure digital (“SD”), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network 150 or another communications connection (either hardwired, wireless, or a combination of hardwired or wireless) to a computer, the computer properly views the connection as a computer readable medium. Thus, any such connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment 110 in which aspects of the disclosure may be implemented. Although not required, some of the embodiments of the claimed systems may be described in the context of computer-executable instructions, such as program modules or engines, as described earlier, being executed by computers in networked environments 100. Such program modules are often reflected and illustrated by flow charts, sequence diagrams, screen displays, and other techniques used by those skilled in the art to communicate how to make and use such computer program modules. Generally, program modules include routines, programs, functions, objects, components, data structures, API calls to other computers whether local or remote, etc. that perform particular tasks or implement particular defined data types, within the computer. Computer-executable instructions, associated data structures and/or schemas, and program modules represent examples of the program code for executing steps of the processes disclosed herein. The particular sequence of such executable instructions or associated data structures represents examples of corresponding acts for implementing the functions described in such steps.

Those skilled in the art will also appreciate that the claimed and/or described systems and processes may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

A system for implementing various aspects of the described operations, which is not illustrated in detail, includes a computing device 130 including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

As will be understood from discussions herein, the present systems and processes may leverage iterative training modules and other advanced/innovative computing techniques to provide an optimized network recommendation for a specific network constituent based on a particular request or classification value. In at least one embodiment, the system may provide an optimized classification value for a specific network constituent as an output of an iterative computing process based at least in part on participation of requisitions, quality of the candidate pool, speed to fulfill requests, costs associated with hired candidates, and/or parameters specifically associated with the retention, turnover, and churn.

The present systems and processes represent an improvement over existing systems and technology. In particular, the present systems and processes are an improvement over existing computing systems for the following non-limiting reasons: 1) the present systems and processes are an improvement over prior systems and processes that may merely compare publicly available data or do not iteratively train modules/models to determine specific network constituents for requests; and 2) the present systems and processes improve upon prior systems by leveraging classification values and assigning emphasis guidelines based on the same, thereby producing more feedback-based recommendations more quickly and potentially reducing computing power and processing time to potentially arrive at the same or similar results (e.g., other systems may require more training on publicly available data to get optimized network recommendations and may never reach the level of accuracy of the present systems and processes).

In addition, the present systems and processes represent an improvement to making network-based decisions generally. In particular, leveraging classification value data with market insights (e.g., an entity's specific brand/diversity goals, customer-specific supplier requirements, competitive benchmarking, and an entity's 5D profile along with request specific parameters like knowledge, skills, abilities, experience, budget, and location etc.) is an improvement over systems and processes that leverage publicly available (e.g., non-entity-specific data) to produce network recommendations and updates to network approved lists to add/remove specific network constituents. Further, the present systems and processes generate network recommendations customized to request specific classification values and can be updated based on user-generated inputs/edits to a plurality of factors.

As will be understood from discussions herein, the present systems and processes may output information and data in addition to network recommendations. The network recommendations may include targets for demographic or geographic locations, renumeration packages including additional employee benefits, other than just a salary, and the system may also output other position-specific factors for the hiring team to consider when extending an offer. The other position-specific factors may include, but are not limited to, stipends, contingent work, flexible working arrangements, remote work, additional education opportunities, etc. In one embodiment, the system may be configured to output a particular network recommendation, along with other supplier, entity, location, or position-specific data produced from other iterative processes as shown in FIGS. 5-7 and discussed in relation to the same. In some embodiments, the system may output one or more factors or parameters that received the highest classification value. In this embodiment (and others), the system outputs a listing of the highest weighted classification value(s) for a particular network constituent that produced a corresponding network recommendation.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices, such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device, or other common network node, and typically include many or all of the elements described above relative to the main computer system in which the systems are embodied. The logical connections between computers include a LAN, a WAN, virtual networks (WAN or LAN), and wireless LAN (“WLAN”) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the WAN, such as the Internet. In a networked environment, program modules depicted relative to the computer, or portions thereof, may be stored in a remote data storage device. It will be appreciated that the network connections described or shown are non-limiting examples and other mechanisms of establishing communications over WAN or the Internet may be used.

Additional aspects, features, and processes of the claimed systems will be readily discernible from the description herein, by those of ordinary skill in the art. Many embodiments and adaptations of the disclosure and claimed systems other than those herein described, as well as many variations, modifications, and equivalent arrangements and processes, will be apparent from or reasonably suggested by the disclosure and the description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and processes for using the same will become apparent from the information disclosed in the exhibits and the other applications as incorporated by reference. Variations and modifications to the disclosed systems and processes may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The description of the disclosed embodiments has been presented only for the purposes of illustration and description and is not intended to be exhaustive or to limit the devices and processes for using the same to the precise forms disclosed. Many modifications and variations are possible in light of the above teaching.

The embodiments were chosen and described in order to explain the principles of the devices and processes for using the same and their practical application so as to enable others skilled in the art to utilize the devices and processes for using the same and various embodiments and with various modifications as are suited to the particular use contemplated.

Alternative embodiments will become apparent to those skilled in the art to which the present devices and processes for using the same pertain without departing from their spirit and scope. Accordingly, the scope of the present devices and processes for using the same is defined by the appended claims rather than the description and the embodiments described therein.

What is claimed is:

1. A process for generating a network related output, the process comprising:
compiling a plurality of network information training data sets, each of the plurality of network information training data sets having a respective one of a plurality of data types and a respective known classification value specific to the respective one of the plurality of data types;
training a plurality of raw training modules with the plurality of network information training data sets by iteratively:
inputting each of the plurality of network information training data sets into a plurality of raw training modules based on the respective one of the plurality of data types thereof;
comparing outputs of the plurality of raw training modules to the respective known classification value for the input ones of the plurality of network information training data sets;
updating one or more emphasis guidelines for a respective plurality of nodes of the plurality of raw training modules based on results of the comparing step;
when the outputs of the plurality of raw training modules are within a preconfigured threshold of the respective known classification value for the input ones of the plurality of network information training data sets, outputting current updated versions of the plurality of raw training modules as a plurality of trained training modules;
receiving a plurality of input network information data sets associated with a specific network constituent, each of the plurality of input network information data sets having a respective one of the plurality of data types;
inputting each of the plurality of input network information data sets through a respective one of the plurality of trained training modules based on the respective one of the plurality of data types thereof;
receiving a plurality of classification values as outputs from the plurality of trained training modules;
determining whether to add or remove the specific network constituent from an approved network list using the plurality of classification values; and
modifying a display based on the plurality of classification values.

2. The process for generating the network related output of claim 1 wherein determining whether to add or remove the specific network constituent from the approved network list using the plurality of classification values comprises:
comparing the plurality of classification values to respective threshold values;
determining whether the specific network constituent is presently included in the approved network list;
removing the specific network constituent from the approved network list when the specific network constituent is determined to be presently included in the approved network list and one or more of the plurality of classification values are below the respective threshold values;
adding the specific network constituent to the approved network list when the specific network constituent fails to be determined to be presently included in the approved network list and each of the plurality of classification values are above the respective threshold values.

3. The process for generating the network related output of claim 1 wherein determining whether to add or remove the specific network constituent from the approved network list using the plurality of classification values comprises:
inputting the plurality of classification values into a trained network constituent approval model; and
receiving a directive to add or remove the specific network constituent from the approved network list as an output of the trained network constituent approval model.

4. The process for generating the network related output of claim 1 further comprising training the trained network constituent approval model by iteratively:
inputting a plurality of known classification values into the trained network constituent approval model, each of the plurality of known classification values being associated with a known approved or rejected network constituent;
comparing an output of the trained network constituent approval model to known approved or rejected network constituent for the input plurality of known classification values; and
updating the trained network constituent approval model based on results of the comparing step.

5. The process for generating the network related output of claim 1 further comprising:
retrieving proprietary bulk data from proprietary data sources and non-proprietary bulk data from non-proprietary data sources; and
transforming the proprietary bulk data and the non-proprietary bulk data into the plurality of network information training data sets according to preconfigured classification guidelines.

6. The process for generating the network related output of claim 5 wherein the proprietary bulk data includes internal reporting on a plurality of network constituents, wherein the non-proprietary data includes self-reporting on the plurality of network constituents from each of the plurality of network constituents.

7. The process for generating the network related output of claim 1 wherein the plurality of data types include network metrics relating to at least one of quality, participation, speed, and cost.

8. The process for generating the network related output of claim 1 further comprising:
compiling an updated plurality of network information training data sets corresponding to each of the plurality of data types, each of the updated plurality of network information training data sets having a respective updated known classification value;
retraining the plurality of trained training modules with the updated plurality of network information training data sets by iteratively:
inputting each of the updated plurality of network information training data sets into the plurality of trained training modules based on the respective one of the plurality of data types thereof;
comparing outputs of the plurality of trained training modules to the respective updated known classification value for the input ones of the updated plurality of network information training data sets; and
updating the one or more emphasis guidelines for the respective plurality of nodes of the plurality of trained training modules based on results of the comparing step.

9. The process for generating the network related output of claim 1, further comprising:
after modifying the display, receiving changes to the plurality of input network information data sets;
processing the changes to the plurality of input network information data sets with the trained training module to generate an updated plurality of classification values; and
modifying the display based on the updated plurality of classification values.

10. The process for generating the network related output of claim 1, further comprising:
generating a plurality of graphical user interface displays that include the plurality of classification values;
receiving user input on at least one of the plurality of graphical user interface displays, the user input modifying the plurality of input network information data sets;
processing the plurality of input network information data sets as modified with the trained training module to generate an updated plurality of classification values; and
generating the updated plurality of classification values on the plurality of graphical user interface displays.

11. A system for generating a network related output, the system comprising:
a memory unit;
a processor in communication with the memory unit, the processor configured to:
compile a plurality of network information training data sets from the memory unit, each of the plurality of network information training data sets having a respective one of a plurality of data types and a respective known classification value specific to the respective one of the plurality of data types;
train a plurality of raw training modules with the plurality of network information training data sets by iteratively:
inputting each of the plurality of network information training data sets into a plurality of raw training modules based on the respective one of the plurality of data types thereof;
comparing outputs of the plurality of raw training modules to the respective known classification value for the input ones of the plurality of network information training data sets;
updating one or more emphasis guidelines for a respective plurality of nodes of the plurality of raw training modules based on results of the comparing step;
when the outputs of the plurality of raw training modules are within a preconfigured threshold of the respective known classification value for the input ones of the plurality of network information training data sets, output current updated versions of the plurality of raw training modules as a plurality of trained training modules;
receive a plurality of input network information data sets associated with a specific network constituent, each of the plurality of input network information data sets having a respective one of the plurality of data types;
input each of the plurality of input network information data sets through a respective one of the plurality of trained training modules based on the respective one of the plurality of data types thereof;
receive a plurality of classification values as outputs from the plurality of trained training modules;
determine whether to add or remove the specific network constituent from an approved network list using the plurality of classification values; and
modify a display based on the plurality of classification values.

12. The system for generating the network related output of claim 11 wherein the processor is configured to determine whether to add or remove the specific network constituent from the approved network list using the plurality of classification values by:
comparing the plurality of classification values to respective threshold values;
determining whether the specific network constituent is presently included in the approved network list;
removing the specific network constituent from the approved network list when the specific network constituent is determined to be presently included in the approved network list and one or more of the plurality of classification values are below the respective threshold values;
adding the specific network constituent to the approved network list when the specific network constituent fails to be determined to be presently included in the approved network list and each of the plurality of classification values are above the respective threshold values.

13. The system for generating the network related output of claim 11 wherein the processor is configured to add or remove the specific network constituent from the approved network list using the plurality of classification values by:
inputting the plurality of classification values into a trained network constituent approval model; and
receiving a directive to add or remove the specific network constituent from the approved network list as an output of the trained network constituent approval model.

14. The system for generating the network related output of claim 11 wherein the processor is further configured to train the trained network constituent approval model by iteratively:
inputting a plurality of known classification values into the trained network constituent approval model, each of the plurality of known classification values being associated with a known approved or rejected network constituent;
comparing an output of the trained network constituent approval model to known approved or rejected network constituent for the input plurality of known classification values; and
updating the trained network constituent approval model based on results of the comparing step.

15. The system for generating the network related output of claim 11 wherein the processor is further configured to:
retrieve proprietary bulk data from proprietary data sources and non-proprietary bulk data from non-proprietary data sources; and
transform the proprietary bulk data and the non-proprietary bulk data into the plurality of network information training data sets according to preconfigured classification guidelines.

16. The system for generating the network related output of claim 15 wherein the proprietary bulk data includes internal reporting on a plurality of network constituents, wherein the non-proprietary data includes self-reporting on the plurality of network constituents from each of the plurality of network constituents.

17. The system for generating the network related output of claim 11 wherein the plurality of data types include network metrics relating to at least one of quality, participation, speed, and cost.

18. The system for generating the network related output of claim 11 wherein the processor is further configured to:
compile an updated plurality of network information training data sets corresponding to each of the plurality of data types, each of the updated plurality of network information training data sets having a respective updated known classification value;
retrain the plurality of trained training modules with the updated plurality of network information training data sets by iteratively:
inputting each of the updated plurality of network information training data sets into the plurality of trained training modules based on the respective one of the plurality of data types thereof;
comparing outputs of the plurality of trained training modules to the respective updated known classification value for the input ones of the updated plurality of network information training data sets; and
updating the one or more emphasis guidelines for the respective plurality of nodes of the plurality of trained training modules based on results of the comparing step.

19. The system for generating the network related output of claim 11, wherein the processor is further configured to:
after modifying the display, receive changes to the plurality of input network information data sets;
process the changes to the plurality of input network information data sets with the trained training module to generate an updated plurality of classification values; and
modify the display based on the updated plurality of classification values.

20. The system for generating the network related output of claim 11, wherein the processor is further configured to:
generate a plurality of graphical user interface displays that include the plurality of classification values;
receive user input on at least one of the plurality of graphical user interface displays, the user input modifying the plurality of input network information data sets;
process the plurality of input network information data sets as modified with the trained training module to generate an updated plurality of classification values; and
generate the updated plurality of classification values on the plurality of graphical user interface displays.
